(19) United States
(12) Patent Application Publication
(10) Pub. No.: US 2025/0267770 A1
(43) Pub. Date: Aug. 21, 2025

(54) HEATING ELEMENT AND FLUID HEATER AND METHOD FOR HEATING A FLUID

(71) Applicant: KANTHAL AB, Hallstahammar (SE)

(72) Inventors: Thomas LEWIN, Hallstahammar (SE); Pengcheng CAO, Hallstahammar (SE)

(73) Assignee: KANTHAL AB, Hallstahammar (SE)

(21) Appl. No.: 18/850,248

(22) PCT Filed: Mar. 29, 2023
(86) PCT No.: PCT/EP2023/058208

§ 371 Date: Sep. 24, 2024

(30) Foreign Application Priority Data
Mar. 30, 2022 (EP) 22165714.1
Jun. 21, 2022 (EP) 22180275.4

(51) Int. Cl. H05B 3/82; F24H 1/10; F24H 3/00

(52) U.S. Cl. CPC H05B 3/82; F24H 1/103; F24H 3/002; H05B 2203/007; H05B 2203/016; H05B 2203/017; H05B 2203/021; H05B 2203/024

(57) ABSTRACT

A heating element for an electric fluid heater, the heating element having an extension along a first axis and comprising fluid permeable heating panels extending at an angle within a range of 45-90 degrees to the first axis and being arranged adjacent to each other along the first axis with an interspace between adjacent heating panels. Each heating panel comprises a 3-dimensional structure, the 3-dimensional structure comprising a multitude of members of at least one electrically conductive material. The heating element has a 3-dimensional shape which is delimited in part by a first lateral side and an opposite second lateral side. The heating panels are electrically connected in series via electrical connectors arranged at the first and second lateral sides. The 3-dimensional structure comprises at least three members arranged after each other along the first axis and connected to each other at nodes.

### TECHNICAL FIELD

The invention relates to a heating element for an electric fluid heater and to an electric fluid heater. The invention also relates to a method for heating a fluid in an electric fluid heater.

### BACKGROUND

Electric heaters may include one or more electrical resistance heating elements arranged for heating a fluid passing through the heater. Conventionally, relatively thin wires, strips or tubes used as the heating elements with the heating effect achieved by the passage of electric current through the respective wires, strips, and tubes.

One kind of electric heater comprises one or more electrically heated channel forming elements for heating a fluid. For instance, WO 2009/071590, EP 2784049, and US 2007/0189741 disclose such heating systems comprising ceramic electric resistance heating elements forming one or more channels, through which a fluid to be heated flows. A current source is connected directly to the relevant electric resistance heating element.

In EP 2784049, the heating system comprises more than one channel forming element which are electrically connected in parallel. Similarly, in the heating system of US 2007/0189741 more than one channel forming elements are electrically connected in parallel while also some of the channel forming elements are connected in series.

Irrespective of the electrical connection of the channel forming heating elements in the systems of WO 2009/071590, EP 2784049, and US 2007/0189741, the individual channel forming heating elements extend along a flow path of the fluid to be heated. That is, the individual channels of the heating elements, through which the fluid to be heated flows, are arranged in parallel along the entire length, over which the fluid is heated.

U.S. Pat. No. 3,244,860 discloses a heater for gas comprising a metal mesh electrical resistance heating element arranged in a casing. A number of concentrically arranged individual mesh strips of hexagonal cross section form the heating element. The individual mesh strips are electrically connected in parallel. A gas flows through the casing and radially inwardly through the mesh strips and is thus, heated.

In contrast with the heating systems of WO 2009/071590, EP 2784049, and US 2007/0189741, in the system of U.S. Pat. No. 3,244,860 the mesh strips are arranged such that the gas flows in sequence, i.e., in series, through the respective mesh strips.

WO 2021/083947 discloses a heating element comprising a main body having a three-dimensional matrix with an open structure including openings and internal voids, cavities and/or pores extending throughout the main body. The three-dimensional matrix is provided as a lattice having a repeating unit cell extending in three directions. The electrical connection of the main body is not discussed in any detail.

DE 102019113518 discloses a fluid heater with a heating element comprising a fabric formed from an insulated wire.

### SUMMARY

There still exists a need for effective and efficient electric heaters for heating fluid.

Thus, it would be advantageous to achieve an efficient electric fluid heater. In particular, it would be desirable to enable a compact electric heater of uncomplicated construction. To better address one or more of these concerns, at least one of a heating element for an electric fluid heater, an electric fluid heater, and a method for heating a fluid in an electric fluid heater as defined in the independent claims is provided.

According to an aspect, there is provided a heating element for an electric fluid heater, the heating element having an extension along a first axis and comprising fluid permeable heating panels extending at an angle within a range of 45-90 degrees to the first axis and being arranged adjacent to each other along the first axis with an interspace between adjacent heating panels. Each heating panel comprises a 3-dimensional structure, the 3-dimensional structure comprising a multitude of members of at least one electrically conductive material. The heating element has a 3-dimensional shape which is delimited in part by a first lateral side and an opposite second lateral side, the first and second lateral sides extending substantially in parallel with the first axis and the heating panels extending between the first and second lateral sides. The heating panels are electrically connected in series via electrical connectors arranged at the first and second lateral sides. The 3-dimensional structure comprises at least three members arranged after each other along the first axis and connected to each other at nodes.

Since the heating panels are arranged adjacent to each other along the first axis with an interspace between adjacent heating panels, since each heating panel comprises a 3-dimensional structure with a multitude of members of at least one electrically conductive material, since the heating panels are electrically connected in series via electrical connectors arranged at the first and second lateral sides, and since the 3-dimensional structure comprises at least three members arranged after each other along the first axis and connected to each other at nodes—the heating element has a compact structure which provides for a high energy transfer in a format that is easily incorporated in an electric fluid heater. Thus, heating element provides for an efficient electric fluid heater.

More specifically, since the heating panels of the heating element are electrically arranged in series, a length of an electrically conductive path through the heating element is longer than a length of the heating element along the first axis. By selecting inter alia the number of heating panels and thus, the length of the electrically conductive path, within the heating element when designing a specific heating element of the herein discussed kind, the electrical resistance and thus, the energy transfer can be flexibly adjusted within a given length of the heating element.

According to a further aspect, there is provided an electric fluid heater comprising a housing having a fluid inlet and a fluid outlet. A fluid flow path for the fluid to be heated is defined within the housing. At least one heating element according to any one of aspects and/or embodiments discussed herein is arranged with its first axis extending along at least part of the fluid flow path.

Since the electric fluid heater comprises at least one heating element according to any one of aspects and/or embodiments discussed herein, a compact and efficient electric fluid heater is provided.

According to a further aspect, there is provided a method for heating a fluid in an electric fluid heater according to any one of aspects and/or embodiments discussed herein. The method comprises steps of:
supplying a fluid to the fluid inlet,
supplying an electric current to the at least one heating element in order to heat the heating panels,
conducting the fluid along the fluid flow path through the heating panels to the fluid outlet, and
leading the fluid from the fluid outlet.

Since the method is performed utilising an electric fluid heater according to any one of aspects and/or embodiments discussed herein, an efficient method for heating a fluid is provided.

As mentioned above, the heating element has a 3-dimensional shape which is delimited in part by a first lateral side and an opposite second lateral side. Accordingly, the heating element may have a generally substantially cylindrical, cube, rectangular cuboid, prism, or parallelepiped shape.

The first and second lateral sides as well as further sides of the heating element form sides of 3-dimensional shape but the heating element may be more or less open from these sides. Put differently, these sides may not necessarily be formed by continuous wall elements. Continuous wall elements may not be required in the heating element as such since the fluid flow path for the fluid to be heated is defined within the housing of the electric fluid heater, in which the heating element is arranged.

It is the first and second lateral sides extending substantially in parallel with the first axis which give the heating element a 3-dimensional shape that can be easily arranged in a housing of an electric fluid heater. This may also contribute to a substantially constant cross sectional area perpendicularly to the first axis throughout the heating element and along the fluid flow path.

More specifically, herein a heating element comprises the heating panels electrically connected in series to each other from a first end portion of the heating element to an opposite second end portion of the heating element, the first and second end portions being seen along the first axis.

The heating panels of one heating element may be arranged along one or more rows in parallel with the first axis. There is an interspace between adjacent heating panels within one row of heating panels and between adjacent heating panels of adjacent rows of heating panels. The heating panels of each row of heating panels extend between the first and second lateral sides of the heating element where the heating panels are electrically connected via the electrical connectors.

An interspace between adjacent heating panels is defined by a void between adjacent heating panels or an electrically non-conductive fluid-permeable material arranged between adjacent heating panels. Specifically, electric current cannot flow through the interspace between adjacent heating panels. Electric current can only flow between two adjacent heating panels at the first or second lateral side of the heating element via one of the electrical connectors.

As mentioned above, the heating panels are electrically connected in series via electrical connectors arranged at the first and second lateral sides. Such electrical connection via electrical connectors may be between adjacent heating panels within a row of heating panels and/or between adjacent heating panels of adjacent rows of heating panels, irrespective of the number of rows of heating panels within the heating element, the heating panels thereof are electrically connected in series from the first end portion of the heating element to the second end portion of the heating element.

Thus, an electrically conductive path is formed through the heating panels of the heating element. The electrically conductive path meanders in one or more directions relative to the first axis. If the heating element comprises only one row of heating panels, the electrically conductive path meanders in only one direction relative the first axis. If the heating element comprises two or more rows of heating panels, the electrically conductive path meanders in two directions relative the first axis.

According to embodiments, an electrically conductive path is provided through the heating element by the heating panels and the electrical connectors, wherein the heating element has a length along the first axis, and wherein the electrically conductive path may be longer than the length along the first axis.

If the heating element comprises only one row of heating panels, adjacent heating panels within the row are electrically connected in series to each other.

According to embodiments, if the heating element comprises only two rows of heating panels i.e., a first row of heating panels and a second row of heating panels, the heating panels of the first and second rows are electrically connected in series alternatingly connecting adjacent heating panels within the first row and within the second row, and alternatingly connecting adjacent heating panels of the first and second rows, such that all heating panels of the first and second rows are electrically connected in series via an electrically conductive path meandering from the first end portion of the heating element to its opposite second end portion.

According to embodiments, if the heating element comprises three or more rows of heating panels i.e., a first outermost row, a second outermost row, and at least one intermediate row between the first and second outermost rows, the heating panels of the three or more rows are electrically connected in series inter alia by connecting adjacent heating panels within adjacent rows. A heating panel of the first outermost row is electrically connected in series via adjacent heating panels of the at least one intermediate row to a heating panel of the second outermost row. Thus, there are formed serially connected lines of heating panels extending across the at least three rows of heating panels and across the first axis. These electrically serially connected lines of heating panels are in turn connected alternatingly via adjacent heating panels within the first outermost row and adjacent heating panels within the second outermost row, such that all heating panels of the at least three rows are electrically connected in series via an electrically conductive path meandering from the first end portion of the heating element to the second end portion.

According to embodiments, the heating panels may be electrically connected in series only via the electrical connectors arranged at the first and second lateral sides.

According to some embodiments, a length of the heating element along the first axis may be longer than a maximum width of the heating element between the first and second lateral sides.

The 3-dimensional structure comprising a multitude of members provides for the fluid permeability of each heating panel. That is, between the multitude of members a multitude of voids are present, through which fluid can penetrate the heating panel.

The multitude of members are connected to each other at a multitude of nodes. Groups of members comprising at least two members of the multitude of members are connected to each other at each node of the multitude of nodes.

The nodes form electrically conductive connections between the members.

Accordingly, an electric current will flow through one member and through a relevant node to a connected further member.

During use of the heating element, within each heating panel, an electric current flows between the first and second lateral sides of the heating element through the multitude of members electrically connected in series and in parallel.

The 3-dimensional structure is a self-supporting structure. That is, the members are stiff or rigid and the connections between the members at the nodes are connections that are rigid i.e., the connections/nodes are able to transfer torque between connected members. Put differently, the connections of the members at the nodes are not journaled or pivotable.

A self-supporting structure is a structure that does not require additional elements or devices, such as a frame, to maintain its structure. Put differently, also without a frame, the positions of the members and the angles between the members within the 3-dimensional structure will be maintained. That is, in the present case, the members and the nodes of the 3-dimensional structure are sufficient for the 3-dimensional structure to maintain its structure.

The heating panels may have any suitable shape as long as they can be arranged adjacent to each other along the first axis with an interspace between adjacent heating panels. For instance, seen in a view along to the first axis, the heating panels may have a round, an oval, a square, a rectangular, or a hexagonal shape. Seen in a side view, perpendicularly to the first axis, each heating panel may have e.g., a rectangular shape, a parallelogram shape, an S-shape, a C-shape, a V-shape, a rhomboid shape.

Each heating panel may have an extension perpendicularly to the first axis e.g., between the first and second lateral sides, which is longer than the extension of the heating panel along the first axis.

Along the first axis, one or more of the heating panels may differ from each other.

A thickness of each heating panel in parallel with the first axis may vary between different portions of one or more of the heating panels.

In a heating panel having a rectangular or parallelepiped shape seen in a view perpendicularly to the first axis, the angle at which the heating panel extends to the first axis is directly apparent.

In a heating panel having a shape that is curved or angled and/or a thickness that varies seen in a view perpendicularly to the first axis, the angle at which the heating panel extends to the first axis is an angle of a centre line of the heating panel i.e., the centre line as seen in the view perpendicularly to the first axis. Depending on the shape of the heating panel, the centre line may be straight or may change direction.

According to embodiments, the heating element may comprise at least 2 heating panels. In this manner, at least two heating panels to be electrically connected in series may be provided.

The heating element may comprise more than 10 heating panels, or more than 50 heating panels, or more than 100 heating panels.

The number of heating panels may depend inter alia on the thickness of the individual heating panels, the total energy transfer to be transferred by the heating element, the voltage to be connected to the heating element, the increase of temperature to be achieved in the heating element, the flow of fluid though the heating element, desired electric resistance, and desired heat transfer performance, etc.

The heating panels are electrically connected in series via the electrical connectors arranged at the first and second lateral sides.

Being arranged at a lateral side means that such an electrical connector may be provided in between adjacent heating panels at a lateral side and/or that such an electrical connector may be provided extending along at least part of adjacent heating panels at a lateral side.

Electrically connecting the heating panels in series provides for flexibility in achieving desired electric resistance values in the heating element. Serially connecting a smaller or larger number of the heating panels provides lower or higher resistance values. The number of panels and accordingly, the total resistance value of the heating element may be selected e.g., such that the heating element can be heated to desired lower or higher temperatures by passing an electric current through the serially connected heating panels. Further, a design power rating, an electrical supply capability, a particular surface loading, etc. may be met by connecting a suitable number of heating panels in series.

According to embodiments, the heating element may comprise at least two rows of heating panels arranged adjacent to each other along the first axis.

According to embodiments, each of the at least two rows of heating panels may comprise at least 2 heating panels.

According to some embodiments, each of the at least two rows of heating panels may comprise within a range of 4-200 heating panels or within a range of 4-500 heating panels.

According to embodiments, the heating panels of the at least two rows of heating panels will be electrically connected in series along an electrically conductive path, from a first end portion of the heating element to an opposite second end portion of the heating element seen along the first axis, via the electrical connectors being arranged alternatingly at the first and second lateral sides. Some of the electrical connectors may extend between adjacent heating panels within a row of heating panels and some of the electrical connectors may extend between heating panels of adjacent rows of heating panels. In this manner, the heating panels arranged in at least two rows may be electrically connected with each other from the first end portion to the second end portion of the heating element. The thus, formed electrically conductive path is meandering through the heating element from the first end portion to the second end portion.

A particular length of the heating element may be required in order to provide a desired temperature increase of a fluid passing along the first axis through the heating element that has been electrically heated to a particular temperature. The length of the heating element is affected by the number of heating panels, the distance between the heating panels, and the length of the respective heating panels along the first axis. Accordingly, also the provision of a suitable length of the heating element may influence the number of heating panels in the heating element.

According to some embodiments, all heating panels of the heating element are electrically connected in series. For instance, along the first axis, adjacent heating panels are alternatingly electrically connected at the first and second lateral sides via the electrical connectors.

The electric resistance of the heating element may be affected by the number of heating panels electrically connected in series. One way of increasing the electric resistance over a given length of the heating element along the first axis may be to arrange heating panels in more than one row in parallel with the first axis and electrically connecting all the heating panels of the more than one rows of heating panels in series to form an electrically conductive path from the first to the second end portion of the heating element. Thus, the heating element may be devised to be electrically heated to a desired temperature by arranging the heating panels connected in series in a number of rows.

According to some embodiments, within the heating element, the heating panels may form two or more sets of heating panels. For instance, the heating panels of such two or more sets of heating panels may be interlaced along the first axis. Within each set of heating panels, the heating panels may be connected in series. Two or more such sets of heating panels may be connected in series or in parallel.

The heating element may comprise two terminals for connecting electric power to the heating element. One terminal may be provided at opposite end portions of the heating element e.g., arranged at the outermost heating panels of the heating element.

In embodiments, wherein the heating element comprises two or more sets of heating panel panels connected in series, each set of heating panels may comprise two terminals for connecting electric power to the respective set of heating panels.

As mentioned above, the 3-dimensional structure of the heating panels comprises at least three members arranged after each other along the first axis and connected to each other at nodes. This means that along the first axis, each heating panel has a length of at least three members. The three members may be arranged at an angle to the first axis. Accordingly, the length of the heating panel along the first axis may be shorter than the total length of three members.

Within the 3-dimensional structure, the members are connected to each other at nodes. A node may be defined by forming a connection point between at least three members and/or a connection point between two members with an abrupt directional change between the members.

The members of the 3-dimensional structure may be arranged more or less regularly within the structure. In a regular arrangement of the members in the 3-dimensional structure, the arrangement of the members is repeated at regular intervals.

The 3-dimensional structure may form a latticework body with a regularly repeating structure of members and nodes. The latticework body forms an open structure i.e., a fluid permeable structure.

The 3-dimensional structure may be advantageous as it can be formed into any shape and configuration. This may be achieved as it is lightweight and strong and may be manufactured by techniques such as additive manufacturing, etc. Due to the open structure of the 3-dimensional structure, the fluid flow to be heated is capable of passing through the heating element.

A further advantage of the 3-dimensional structure may be the availability and freedom of choice to design fluid flow path/s through the structure. For instance, a relatively dense structure may provide a higher fluid flow resistance than a less dense structure.

According to embodiments, the 3-dimensional structure comprises voids between the members, the voids permitting the fluid to pass through the heating panel, and wherein a void to member volume ratio of the 3-dimensional structure may be within a range of 1:1 to 10000:2. In this manner, an efficient energy transfer may be provided by the heating elements.

According to embodiments, the members are connect at nodes to form a multitude of unit cells. In this manner, the 3-dimensional structure may be provided in an efficient and repeatable manner e.g., suited for being produced in an additive manufacturing process.

Accordingly, the smallest repeating structure of the 3-dimensional structure may be a unit cell.

In the context of a unit cell, the members may be referred to as struts. Herein, the term member will be used for the struts of a unit cell.

As such, within the 3-dimensional structure a first unit cell may share members and nodes with an adjacent second unit cell. That is, members and nodes bordering between first and second unit cells may be seen to form part of each of the first and second unit cells.

In the 3-dimensional structure, the regularly repeating structure may extend in three directions, a first, a second, and a third direction. One of these directions may coincide with the first axis. Alternatively, none of these directions coincides with the first axis.

In case of the 3-dimensional structure being formed by unit cells, the unit cells are arranged adjacent to each other in three directions. The three directions may extend at the same angle to each other. That is, the angle between the first and second directions may equal the angle between the second and third directions and the angle between the first and third directions. For instance the angle between the directions may be 90 degrees or 60 degrees.

The 3-dimensional structure being formed by unit cells may be advantageous to withstand the thermal, physical and mechanical demands within the heating element.

According to embodiments, a first heating panel may differ from a second heating panel by any one or a combination of:
the 3-dimensional structure;
a cross-sectional area, thickness or width of the members;
a size, shape, or number of voids within the heating panels;
a length along the first axis of the heating panels. In this manner, different properties may be imparted on the first and second heating panels.

Thus, for instance, an electric resistance of the first and second heating panels may differ, a flow resistance of the first and second heating panels may differ, etc. Such differences may be desired depending on a position of the relevant first and second heating panels in the heating element.

According to the present disclosure any material which could be used as electrically conductive material is suitable. Thus, according to embodiments, the at least one electrically conductive material is selected from the group of iron-chromium-aluminium (FeCrAl) alloy, nickel-chromium alloy, copper-nickel based alloy, iron-nickel-chromium alloy, nickel-iron-chromium-aluminium alloy, ceramic material, intermetallic material, tungsten-based composition, and molybdenum-based composition or a combination thereof. According to embodiments, the material may be selected from graphite or stainless steel. According to embodiments, tungsten-based composition and molybdenum-based composition may be selected from compositions comprising tungsten/molybdenum and silica.

According to embodiments, each of the heating panels may be a result of an additive manufacturing process. In this manner, the heating panels may be manufactured in an efficient manner in one or more of the materials discussed herein.

In particular, utilising additive manufacturing, the 3-dimensional structure may be manufactured precisely on a small-scale level i.e., at a level of each member. Precisely manufactured heating panels for specific energy transfer ranges thus, may be provided.

For instance, additive manufacturing permits production of members having a thickness as thin as 0.1 mm and a length as short as 0.1 mm. Typically a thickness may be within a range of 0.2-1 mm. But the thickness range may be 0.1-10 mm or more. Typically, the length of the members may be within a range of 0.5-5 mm. But the length range may be 0.1-50 mm.

Moreover, the additive manufacturing process provides an efficient way of producing the 3-dimensional structure of the heating panels as a regularly repeating structure of the multitude of members. As for instance in embodiments wherein the members form part of unit cells, the members and nodes may be efficiently produced.

Lightweight and strong members may be manufactured by additive manufacturing. Advanced member and node structures as well as providing flexibility in producing a fluid permeable 3-dimensional structure may be achieved in an additive manufacturing process.

According to embodiments, the electrical connectors may be a result of an additive manufacturing process. In this manner, the heating panels and the electrical connectors of the heating element may be manufactured in one manufacturing process.

That is, the main portion of the heating element, the heat producing heating panels and the electrical connectors providing the serial connection between the heating panels, may be easily and efficiently produced as a unitary body by an additive manufacturing process. Such a unitary body may require only minor further manufacturing steps before being ready to be arranged in an electric fluid heater.

The electrical connectors may be of the same or similar 3-dimensional structure as the heating panels. Alternatively, the electrical connectors may be of solid material.

The electrical connectors may be of the same electrically conductive material as the heating panels. Alternatively, the electrical connectors may be of a different electrically conductive material than the heating panels.

According to embodiments of the heating element comprising terminals for connecting electric power to the heating panels, also the terminals may be a result of an additive manufacturing process.

In such embodiments, the heating element including the heating panel, the electric connectors, and the terminals being manufacture in an additive manufacturing process, none or only minor further manufacturing steps may be required before being ready to be arranged in an electric fluid heater.

According to embodiments, the heating element may comprise electrically non-conductive spacer elements arranged between adjacent heating panels of a row of heating panels at the first and second lateral sides. In this manner, it may be ensured that individual heating panels do not short circuit within the heating element. Also, a stability of the heating element may be improved by the provision of the spacer elements.

According to embodiments, wherein the heating element comprises at least two rows of heating panels, at least one electrically non-conductive further spacer element may be arranged between adjacent heating panels of adjacent rows of heating panels. In this manner, it may be ensured that individual heating panels do not short circuit between rows of heating panels within the heating element. Also, a stability of the heating element may be improved by the provision of the further spacer elements.

During use of the electric fluid heater, the fluid to be heated passes through at least one heating element and is heated therein. That is, the fluid the be heated enters the electric fluid heater, passes therethrough, and leaves the electric fluid heater at an elevated temperature. For instance, this may be done in accordance with the herein discussed method.

The electric fluid heater may be utilised for heating a fluid flow in any industrial or domestic apparatus or process. The fluid may be a gas, such as air. Thus, the electric fluid heater may be for heating a gas flow. The fluid may be a liquid. Thus, the electric fluid heater may be for heating a liquid flow or for heating a vapour.

The heating element may be arranged within the housing of the electric fluid heater such that the heating element fills the fluid flow path, at least in a direction perpendicularly to the first axis. Thus, the entire fluid flow may pass through the heating element along the first axis.

The electric fluid heater may comprise more than one heating element of same or different kinds arranged with its respective first axis arranged along the flow path. The heating elements may for instance differ with respect to the temperature to which they are electrically heated, the electrically conductive material of the heating panels, the number of heating panels, the length of the heating elements along their respective first axes, the 3-dimensional structure of the heating panels, etc.

The more than one heating elements may be arranged one after the other along the flow path, and/or the more than one heating elements may be arranged in parallel along the flow path.

In the fluid heater, the more than one heating elements may be electrically connected in series and/or electrically connected in parallel.

Further features of, and advantages with, the invention will become apparent when studying the appended claims and the following detailed description.

### BRIEF DESCRIPTION OF THE DRAWINGS

Various aspects and/or embodiments of the invention, including its particular features and advantages, will be readily understood from the example embodiments discussed in the following detailed description and the accompanying drawings, in which:

FIGS. 1a-1c illustrate a heating element according to embodiments,

FIGS. 2a)-2c) illustrate portions of 3-dimensional structures according to embodiments,

FIGS. 3a-3c illustrate an electric fluid heater according to embodiments,

FIGS. 4a and 4b illustrate an electric fluid heater according to embodiments,

FIG. 5 illustrates a method for heating a fluid,

FIGS. 6a-6d illustrate four heating elements according to embodiments,

FIGS. 7a and 7b illustrate a heating element according to embodiments, and

FIGS. 8a-8d illustrate two heating elements according to embodiments.

### DETAILED DESCRIPTION

Aspects and/or embodiments of the invention will now be described more fully. Like numbers refer to like elements throughout. Well-known functions or constructions will not necessarily be described in detail for brevity and/or clarity.

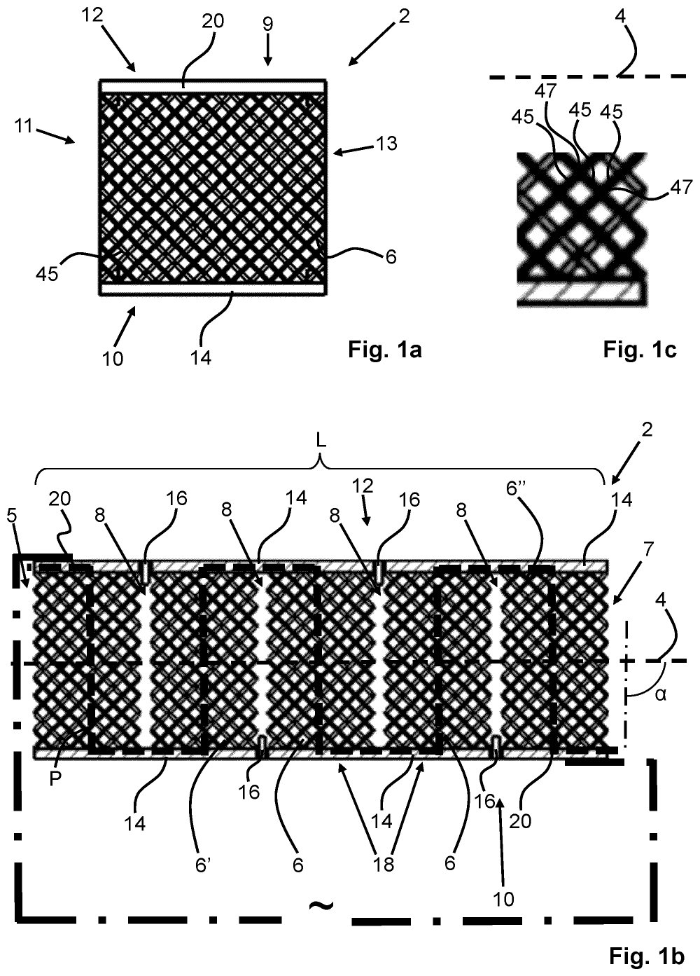

FIGS. 1a-1c illustrate a heating element 2 according to embodiments. In FIG. 1a, the heating element 2 is shown in an end view i.e., a view showing an inlet end or an outlet end of the heating element 2. In FIG. 1b, the heating element 2 is shown in a side view i.e., in a view along a fluid flow path through the heating element 2. FIG. 1c shows a portion of a 3-dimensional structure of the heating element 2.

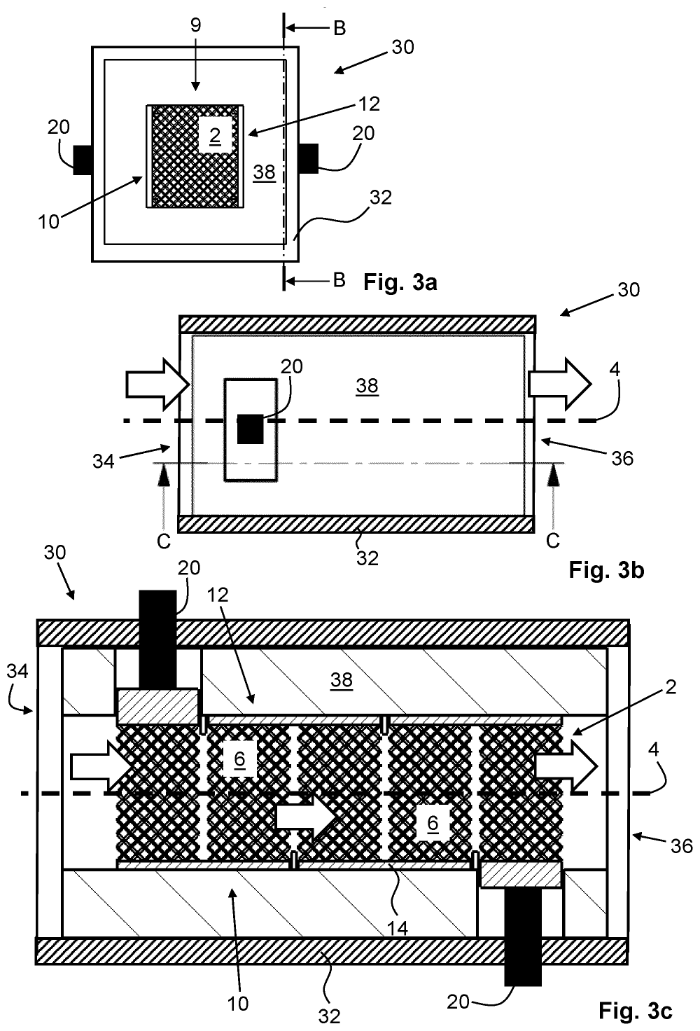

The heating element 2 is configured for use in an electric fluid heater. When arranged in an electric fluid heater, in the electric fluid heater a fluid flow path is delimited such that the fluid to be heated flows through the heating element 2. See further below e.g., with reference to FIGS. 3a-3c.

The heating element 2 has an extension along a first axis 4, indicated with a narrow broken line in FIG. 1c. Seen along the first axis 4, the heating element 2 has a first end portion 5 and an opposite second end portion 7. The fluid to be heated in the heating element 2, flows along a fluid flow path in parallel with the first axis 4 through the heating element 2.

The heating element 2 comprises a number of fluid permeable heating panels 6. The heating panels 6 are arranged adjacent to each other along the first axis 4 with an interspace 8 between adjacent heating panels 6. The heating panels 6 are arranged along one row 9.

Each of the heating panels 6 extends at an angle α within a range of 45-90 degrees to the first axis 4. In the illustrated embodiments, the heating panels 6 extend perpendicularly to the first axis 4 i.e., the angle α is 90 degrees.

According to some embodiments, as in the illustrated embodiments, the heating panels 6 may be arranged extending in parallel with each other.

The heating element 2 has a 3-dimensional shape which is delimited in part by a first lateral side 10 and an opposite second lateral side 12. The first and second lateral sides 10, 12 extend substantially in parallel with the first axis 4. The heating panels 6 of the heating element 2 extend between the first and second lateral sides 10, 12. That is the heating panels 6 extend across the first axis 4.

In the illustrated embodiments, the heating element 2 has a generally rectangular cuboid shape. Accordingly, the 3-dimensional shape of the heating element 2 is delimited by further opposed lateral sides 11, 13. Also the further lateral sides 11, 13 extend substantially in parallel with the first axis 4.

A lateral side extending substantially in parallel with the first axis may mean that the relevant lateral side extends at an angle within a range of 0-5 degrees to the first axis 4.

The heating panels 6 are made of at least one electrically conductive material. The heating panels 6 are electrically connected in series via electrical connectors 14. The electrical connectors 14 are arranged at the first and second lateral sides 10, 12.

Between two adjacent heating panels 6, electric current can only flow via the electrical connector 14 arranged therebetween. No electric current can flow through the interspace 8 between two adjacent heating panels 6.

More specifically, the electrical connectors 14 are arranged alternatingly at the first and second lateral sides 10, 12. In this manner, an electric current through the heating element 2 will flow in series through the individual heating panels 6 between the first and second end portions 5, 7 of the heating element 2.

According to some embodiments, the heating panels 6 are electrically connected in series only via the electrical connectors 14 arranged at the first and second lateral sides 10, 12.

An electrically conductive path P, indicated with a broad broken line in FIG. 1c, is provided through the heating element 2 by the heating panels 6 and the electrical connectors 14. Also, the heating element 2 has a length L along the first axis 4. Since the heating panels 6 are electrically connected in series via the electrical connectors 14 arranged at the first and second lateral sides 10, 12, the electrically conductive path P through the heating element 2 is longer than the length L of the heating element 2 along the first axis 4. As discussed herein, the electrically conductive path P is meandering through the heating element 2.

According to some embodiments, the heating element 2 may comprise electrically non-conductive spacer elements 16 arranged between adjacent heating panels 6 at the first and second lateral sides 10, 12. Thus, the heating panels 6 are prevented from coming too close to each other at their lateral sides 10, 11, 12, 13, where the heating panels 6 are not connected to each other via the electrical connectors 14. Since the spacer elements 16 are arranged at the first and second lateral sides 10, 12, the spacer elements 16 do not impede the flow of fluid to be heated through the heating element 2, at least not to any substantial extent.

According to some embodiments, along the first lateral side 10, one of the electrical connectors 14 may extend between two adjacent heating panels 6 to form a pair 18 of heating panels 6 and one of the spacer elements 16 may be arranged between the pair 18 of heating panels 6 and a further adjacent heating panel 6′. Along the second lateral side 12, one of the spacer elements 16 may be arranged between the two heating panels 6 of the pair 18 of heating panels 6 and one of the electrical connectors 18 may extend between one of the heating panels 6 of the pair 18 of heating panels 6 and the further adjacent heating panel 6′.

In the illustrated embodiments, the heating element 2 comprises two terminals 20 for connecting electric power to the heating element 2, as indicated by the dash-dotted line. One terminal 20 is provided at each opposite end portion of the heating element 2, seen along the first axis 4.

Each of the heating panels 6 comprises a 3-dimensional structure. The 3-dimensional structure comprises a multitude of members 45 of the at least one electrically conductive material.

The 3-dimensional structure comprising the multitude of members 45 provides for the fluid permeability of each heating panel 6. In the 3-dimensional structure, between the multitude of members 45 a multitude of voids are present, through which voids fluid can penetrate the heating panels 6.

The 3-dimensional structure comprises at least three members 45 arranged after each other along the first axis 4 and connected to each other at nodes 47, see FIG. 1c.

In the illustrated embodiments of FIGS. 1a-1c, the member 45 and nodes 47 are arranged to form numerous unit cells having an octahedron shape.

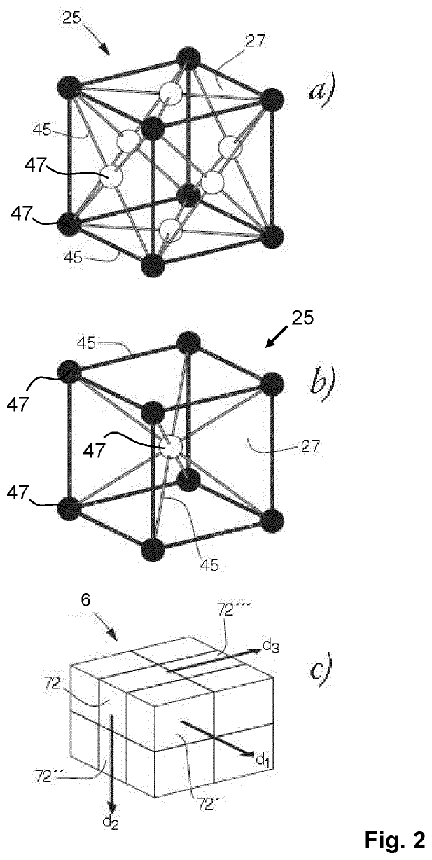

See below with reference to FIGS. 2a)-2c) for a further discussion of details of the 3-dimensional structure and alternative 3-dimensional structures.

The at least one electrically conductive material used is any material which can conduct electricity. Thus, the material is selected from the group of iron-chromium-aluminium alloy, nickel-chromium alloy, copper-nickel based alloy, iron-nickel-chromium alloy, nickel-iron-chromium-aluminium alloy, ceramic material, intermetallic material, tungsten-based composition, and molybdenum-based composition, or a combination thereof.

The 3-dimensional structure comprises voids between the members, the voids permitting the fluid to pass through the heating panel 6. A void to member volume ratio of the 3-dimensional structure may be within a range of 1:1 to 10000:2.

According to some embodiments, each of the heating panels 6 may be a result of an additive manufacturing process. Also, one or more of the electrical connectors 14 and/or the terminals 20 may be a result of an additive manufacturing process.

According to embodiments, a thickness of the members 45 may be within a range of 0.05-mm, or within a range of 0.1-4 mm, or within a range of 0.2-1 mm and a length of the members 45 may be within a range of 0.1-50 mm, or within a range of 0.2-15 mm or within a range of 0.5-5 mm.

The thickness of a member 45 extends perpendicularly to the length of the member 45. When the thickness of a member 45 varies, the above discussed thickness ranges relate to a mean thicknesses of the member 45.

In the illustrated embodiments, the heating element 2 comprises five heating panels 6. According to alternative embodiments, the heating element 2 may comprise more or less than five heating panels 6.

According to some embodiments, a first heating panel 6′ may differ from a second heating panel 6″ by any one or a combination of:
the 3-dimensional structure;
a cross-sectional area, thickness or width of the members;
a size, shape, or number of voids within the heating panels 6′, 6″;
a length along the first axis 4 of the panels 6′, 6″.

Thus, different properties may be provided by the first and second heating panels 6′, 6″ at different positions within the heating element 2.

According to embodiments, the heating panels may be designed and arranged for an energy transfer of up to 5 kW/cm3. In this manner, a compact heating element providing a high, and thus, efficient energy transfer, may be provided.

According to embodiments, the heating panels may be configured to be electrically heated up to a temperature of 1450 degrees Celsius, up to a temperature of 1900 degrees Celsius, or up to a temperature within a range of 1700-1900 degrees Celsius, or up to temperature within a range of 1600-2000 degrees Celsius. In this manner, the fluid to be heated may be heated to high temperatures, which may be utilised in industrial processes.

Such a temperature or temperature range may be applied in heaters wherein the electrically conducting material is selected from any of the above-mentioned alloys.

According to some embodiments, such a temperature of up to 1450 degrees Celsius may be applied in heating elements 2 wherein the electrically conducting material is a FeCrAl (iron-chromium-aluminium) alloy or a Nickel-based alloy.

According to some embodiments, such a temperature of up to 1900 degrees Celsius or the temperature range of 1700-1900 degrees Celsius may be applied in heating elements wherein the electrically conducting material is a molybdenum-based alloy.

According to some embodiments, such a temperature of up to 2000 degrees Celsius or the temperature range of 1600-2000 degrees Celsius may be applied in heating elements wherein the electrically conducting material is a silicon-based alloy.

FIGS. 2a)-2c) illustrate portions of 3-dimensional structures according to embodiments. Such 3-dimensional structures may be a 3-dimensional structure similar to the one discussed above with reference to FIGS. 1a-1c. Accordingly, in the following reference is also made to FIGS. 1a-1c.

As mentioned above, each of the heating panels of a heating element comprises a 3-dimensional structure. The 3-dimensional structure comprises a multitude of members 45 of at least one electrically conductive material. Between the multitude of members 45 a multitude of voids are present.

According to these embodiments, the 3-dimensional structure comprises a regularly repeating structure of members 45 and nodes 47.

Similarly, to the 3-dimensional structure discussed above with reference to FIGS. 1a-1c, when arranged in a heating panel 6 of a heating element 2, the 3-dimensional structure comprises at least three members 45 arranged after each other along the first axis 4 and connected to each other at nodes 47.

FIGS. 2a) and 2b) each illustrates one so-called unit cell 25. The unit cell 25 comprises members 45 connected at nodes 47. In a heating panel 6 of a heating element 2 there are arranged a multitude of unit cells 25. That is, the members 45 of the 3-dimensional structure are connect at nodes 47 to form a multitude of unit cells 25.

FIGS. 2a) and 2b) illustrate examples of the smallest repeating structure of the 3-dimensional structure, a unit cell 25. Each unit cell 25 is formed from stiff or rigid members 45 that are connected at the nodes 47. The connection between the members 45 at the nodes 47 is rigid. Accordingly, a unit cell 25 is self-supporting and a structure comprising a number of unit cells 25 is also self-supporting.

There are voids 27 between the members 45 and the nodes 47.

Accordingly, the regularly repeating structure of members 45 and nodes 47 with the voids therebetween is a fluid permeable structure. The fluid flow is heated by the electrically heated members 45 and nodes 47 as it passes through the fluid permeable structure.

Such unit cells 25 may be repeated throughout at least a main portion of the 3-dimensional structure.

In different heating panels 6 of a heating element 2, the 3-dimensional structure may comprise different unit cell geometries to form heating panels 6 that differ in the size, shape and multiplicity of the members 45 and/or the voids 27.

The example unit cell configuration of FIG. 2a), it is a face-centred-cubic (fcc) unit cell 25. The example unit cell configuration of FIG. 2b), it is body-centred-cubic (bcc) unit cell 25.

Accordingly, the feature that the 3-dimensional structure of each heating panel 6 comprises at least three members 45 arranged after each other along the first axis 4 and connected to each other at nodes 47 means in embodiments wherein the 3-dimensional structure comprises fcc unit cells 25 as shown in FIG. 2a) or bcc unit cells 25 as shown in FIG. 2b), that the 3-dimensional structure comprises at least one-and-a-half unit cells 25 arranged along the first axis 4.

In a 3-dimensional structure comprising simple cubic unit cells i.e., without any centred nodes, the feature that the 3-dimensional structure comprises at least three members 45 arranged after each other along the first axis 4 and connected to each other at nodes 47 means, that the 3-dimensional structure comprises at least three unit cells 25 arranged along the first axis 4.

A unit cell 25 may have a diameter, or width of at least 0.1 mm. A member 45 may have a diameter of at least 0.05 mm. According to some embodiments, a member 45 may have a diameter or a mean diameter which is greater than 0.05 mm, such as 0.05 to 4 mm. The diameter and mean diameter of a member 45 is measured perpendicularly to a longitudinal extension of a member 45. The mean diameter is the average diameter in case the member 45 does not have a circular cross section and/or if the diameter changes along an extension of the member 45.

FIG. 2c) illustrates a number of unit cells 72 of a portion of a 3-dimensional structure of a heating panel 6. The 3-dimensional structure is a self-supporting structure.

Each unit cell 72 is schematically shown as a cube and may be of one of the kinds discussed in connection with FIGS. 2a) and 2b). However, the unit cells 72 are not limited to the shown embodiments but may have any suitable internal structure of members and any suitable other outer shape, such as e.g. a tetrahedron shape or octahedron shape.

The unit cells 72 are arranged next to each other in three dimensions. Members and nodes of adjacent unit cells 72 are shared to form a regularly repeating 3-dimensional structure in the heating panel 6. More specifically, at corners of each unit cell 72, members from adjacent unit cells 72 are connected to each other and thus, form nodes. Since each unit cell 72, except at outer surfaces of the heating panel 6, is surrounded by other unit cells 72, the unit cells are positioned next to each other in three dimensions. For instance, the heating panel 6 comprises at least two unit cells 72, 72′ positioned adjacent to each other in a first direction d1, at least two unit cells 72, 72″ positioned adjacent to each other in a second direction d2, and at least two unit cells 72, 72′″ positioned adjacent to each other in a third direction d3, wherein the first, second, and third directions d1, d2, d3 are arranged at an angle to each other. For instance, if the unit cells 72 have cubic shape, as illustrated, the three directions d1, d2, d3 are orthogonal, if the unit cells 72 have tetrahedron shape, the three directions extend at an angle of 120 degrees to each other.

According to some embodiments, one of the first, second, and third directions d1, d2, d3 may coincide with the first axis 4.

According to some embodiments, different basic unit cells may be superimposed. For instance, an FCC unit cell may be added to a BCC unit cell and they may be manufactured simultaneously e.g., by additive manufacturing. Further, the 3-dimensional structure may comprise different types of unit cells occupying the same volume. By different types of unit cells are meant for example unit cells having different configuration, being differently sized e.g., different thicknesses of the members.

FIGS. 3a-3c illustrate an electric fluid heater 30 according to embodiments. In FIG. 3a, the electric fluid heater 30 is shown in an end view i.e., a view showing an inlet end or an outlet end of the electric fluid heater 30. In FIG. 3b, a cross section of the electric fluid heater 30 along line B-B in FIG. 3a is shown. In FIG. 3c, a cross section along of the electric fluid heater 30 along line C-C in FIG. 3b is shown.

The electric fluid heater 30 comprises a housing 32. The housing 32 has a fluid inlet 34 and a fluid outlet 36. A fluid flow path for the fluid to be heated is defined within the housing 32. The fluid flow path extends from the fluid inlet 34 to the fluid outlet 36. The fluid flow path is indicated with broad arrows in FIGS. 3b and 3c.

The housing 32 may be formed by a pipe or a portion of a pipe. The housing 32 may be a pressure vessel.

A heating element 2 according to any one of aspects and/or embodiments discussed herein is arranged with its first axis 4 extending along at least part of the fluid flow path. That is the first axis 4 of the heating element 2 extends at least in part in parallel with the fluid flow path.

Accordingly, the heating element 2 comprises inter alia heating panels 6 electrically connected to each other via electrical connectors 14. The heating element 2 has first and second lateral sides 10, 12 extending substantially in parallel with the first axis 4. For instance, the heating element 2 may be a heating element 2 with the heating panels 6 arranged along one row 9 as discussed above with reference to FIGS. 1a-1c.

In the embodiments of FIGS. 3a-3c only one heating element 2 is arranged in the housing 32. In alternative embodiments, more than one heating element may be arranged in the housing. Such more than one heating element may be arranged in series along the fluid flow path and/or in parallel along the fluid flow path. That is, the fluid to be heated may flow in sequence through the more than one heating elements and/or in parallel through the heating elements.

According to some embodiments, such as the illustrated embodiments, the electric fluid heater 30 may comprise an insulation material 38 arranged at least along part of the fluid flow path. In this manner, the heating element 2 may be thermally and electrically insulated from the housing of the electric fluid heater 30. Also, the fluid flow path may be delimited by the insulation material 38 i.e., the insulation material 38 may define the fluid flow path within at least part of the housing 30.

The heating element 2 is easily positionable in the housing 30 due to its first and second lateral sides 10, 12 extending substantially in parallel with the first axis 4. Thus, assembly and/or maintenance of the electric fluid heater 30 is facilitated as the heating element 2 can be easily inserted into and extracted from the housing 30. The heating element 2 may be inserted into or extracted from the insulation material 38 being arranged in the housing 30. Alternatively, the heating element 2 may be inserted into or extracted from the housing together with the insulation material 38.

The electric fluid heater 30 comprises two terminals 20 for connecting electric power to the heating element 2 and the heating panels 6.

The terminals 20 may form part of the heating element 2. Alternatively, the terminals 20 may form separate parts that are separately mounted in the electric fluid heater 30 and connected to the heating panels 6 at the respective ends of the heating element 2. A further option may be for the terminals 20 to comprise two or more components, some of the terminal components forming part of the heating element 2 and other terminal components being separately mounted in the electric fluid heater 30.

The terminals 20 may extend laterally through walls of the housing 32 to outside the housing 32 as shown in FIGS. 3a-3c. Alternatively, one or both terminals 20 may extend via the fluid inlet 34 and/or the fluid outlet 36 to outside the housing 32.

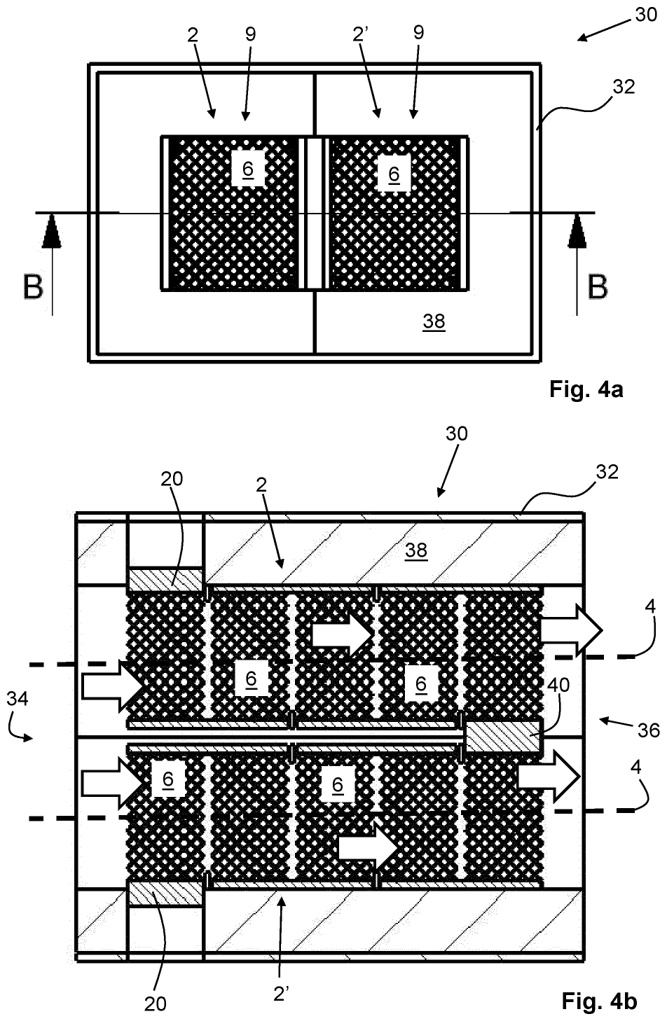

FIGS. 4a and 4b illustrate an electric fluid heater 30 according to embodiments. In FIG. 4a, the electric fluid heater 30 is shown in an end view i.e., a view showing an inlet end or an outlet end of the electric fluid heater 30. In FIG. 4b, a cross section of the electric fluid heater 30 along line B-B in FIG. 4a is shown.

The electric fluid heater 30 resembles in much the electric fluid heater 30 of the embodiments of FIGS. 3a-3b. Accordingly, In the following, mainly the differences between the FIGS. 4a-4b embodiments and the FIGS. 3a-3c will be discussed.

Again, the electric fluid heater 30 comprises a housing 32. The housing 32 has a fluid inlet 34 and a fluid outlet 36. A fluid flow path, indicated with broad arrows, for the fluid to be heated is defined within the housing 32. An insulation material 38 is arranged at least along part of the fluid flow path.

In the embodiments of FIGS. 4a-4b, two heating elements 2, 2′ are arranged in the housing 32. The two heating elements 2, 2′ are arranged in parallel along the fluid flow path. That is, the respective first axis of the heating elements 2 are arranged in parallel with each other and at least part of the fluid flow path.

In each heating element 2, 2′ the heating panels 6 are arranged along one row 9 of heating panels 6.

The two heating elements 2, 2′ are electrically connected in series. An electrically conductive element 40 is arranged between the outermost heating panels 6 arranged at the same ends of the two heating elements 2, 2′. Via the electrically conductive element 40 the two heating elements 2, 2′ are electrically connected.

Again, the electric fluid heater 30 comprises two terminals 20 for connecting electric power to the heating elements 2, 2′. Since the two heating elements 2, 2′ are electrically connected in series, the terminals 20 are arranged at the same end of the electric fluid heater 30.

In alternative embodiments, the two heating elements 2, 2′ may be electrically connected in parallel. This would provide a configuration of the electric fluid heater 30, wherein within each heating element 2 the heating panel 6 are electrically connected in series and the two heating elements 2, 2′ are connected in parallel.

Further electrical connection alternatives of the heating elements 2 are also possible. For instance, if the electric fluid heater 30 comprises three heating elements 2, the heating elements can be connected to three phase alternating current via a star connection or a delta connection.

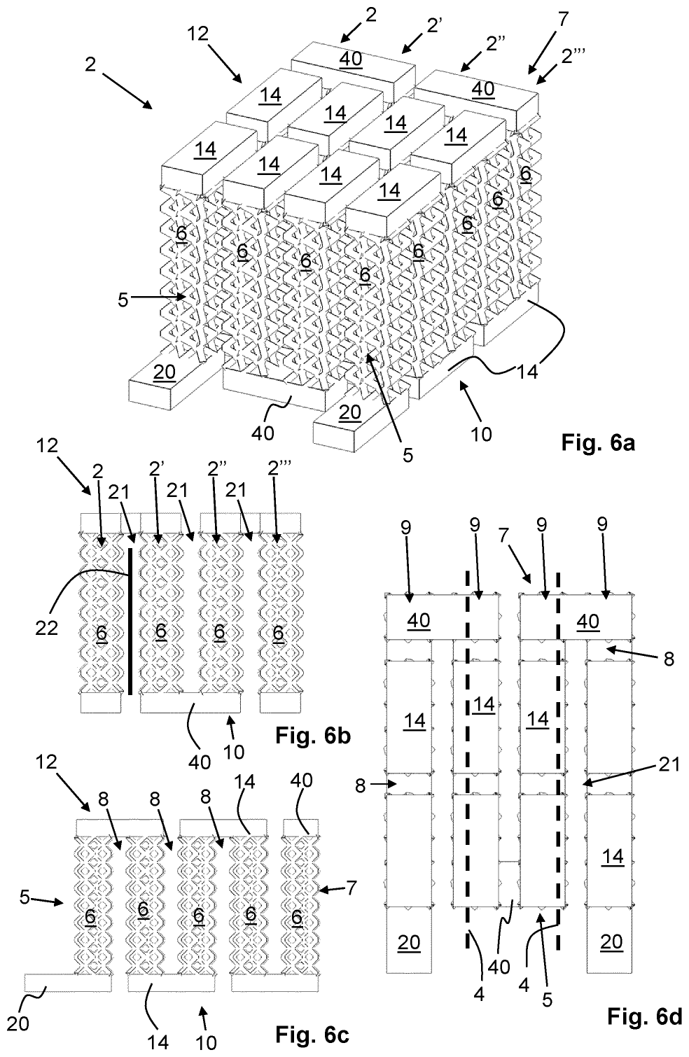

FIGS. 6a-6d illustrate four heating elements 2, 2′, 2″, 2′″ according to embodiments. In FIG. 6a, the heating elements are shown in an isometric view. In FIG. 6b, the heating elements are shown in an end view. FIG. 6c shows the heating elements in a side view. FIG. 6d shows the heating elements in a top view.

The heating elements 2, 2′, 2″, 2′″ of these embodiments resemble in much the heating elements 2, 2′ discussed herein, such as above with reference to FIGS. 1a-4b.

Again, each heating element 2, 2′, 2″, 2′″ has an extension along a first axis 4, indicated with broken lines. Seen along the first axis 4, each the heating element 2, 2′, 2″, 2′″ has a first end portion 5 and an opposite second end portion 7.

Similarly, to the embodiments of FIGS. 4a-4b, the heating elements 2, 2′, 2″, 2′″ are arranged with their respective first axes 4 in parallel. The fluid to be heated in the heating elements 2, 2′, 2″, 2′″ flows along a fluid flow path in parallel with the first axes 4 through the heating elements 2, 2′, 2″, 2′″.

Again, each heating element 2, 2′, 2″, 2′″ comprises a row 9 of fluid permeable heating panels 6. The heating panels 6, in this example 5 heating panels 6 per heating element, are arranged adjacent to each other along the first axis 4 with an interspace 8 between adjacent heating panels 6 in each heating element 2, 2′, 2″, 2′″. Each heating element 2, 2′, 2″, 2′″ may comprise less or more than 5 heating panels 6.

Moreover, there are also interspaces 21 between adjacent heating panels 6 of adjacent heating elements 2, 2′, 2″, 2′″.

Again, each heating element 2, 2′, 2″, 2′″ has a 3-dimensional shape which is delimited in part by a first lateral side 10 and an opposite second lateral side 12.

Again, within each heating element 2, 2′, the heating panels 6 are electrically connected in series via electrical connectors 14. The electrical connectors 14 are arranged at the first and second lateral sides 10, 12.

Again, the heating panels 6 of one heating element 2, 2′, 2″, 2′″ are electrically connected in series along an electrically conductive path, from the first end portion 5 to the second end portion 7 of the heating element 2, 2′, 2″, 2′″, seen along the first axis 4, via the electrical connectors 14 being arranged alternatingly at the first and second lateral sides 10, 12.

The four heating elements 2, 2′, 2″, 2′″ are electrically connected in series. three electrically conductive elements 40 are arranged between the last heating panel 6 of the heating elements 2, 2′, 2″, 2′″ at the first and second end portion 7. Via each electrically conductive element 40 two heating elements 2, 2′, 2″, 2′″ are electrically connected in series.

The heating elements 2, 2′″ first and last in the serial connection comprise a terminal 20 for connecting electric power to the heating elements 2, 2′, 2″, 2′″. Since the four heating elements 2, 2′, 2″, 2′″ are electrically connected in series, the terminals 20 are both arranged at the same end portion of the first and last heating elements 2, 2′″, in the illustrated embodiments at the first end portion 5.

Again, electrically non-conductive spacer elements (not shown) may be arranged between adjacent heating panels 6 of the respective heating elements 2, 2′, 2″, 2′″. The spacer elements are arranged between the heating panels 6 in a manner such that they do not impede the flow of fluid to be heated through the heating elements 2, 2′, 2″, 2′″, at least not to any substantial extent.

Moreover, one or more electrically non-conductive further spacer elements 22 may be arranged between the heating panels 6 of adjacent heating elements 2, 2′, 2″, 2′″. One such further spacer element 22 is schematically indicated in FIG. 6b.

According to some embodiments, such further spacer elements 22 may at least partially delimit the flow path through the heating elements 2, 2′, 2″, 2′″ into separate flow passages.

Again, the four heating elements 2, 2′, 2″, 2′″ may be arranged in a housing to collectively form a fluid heater.

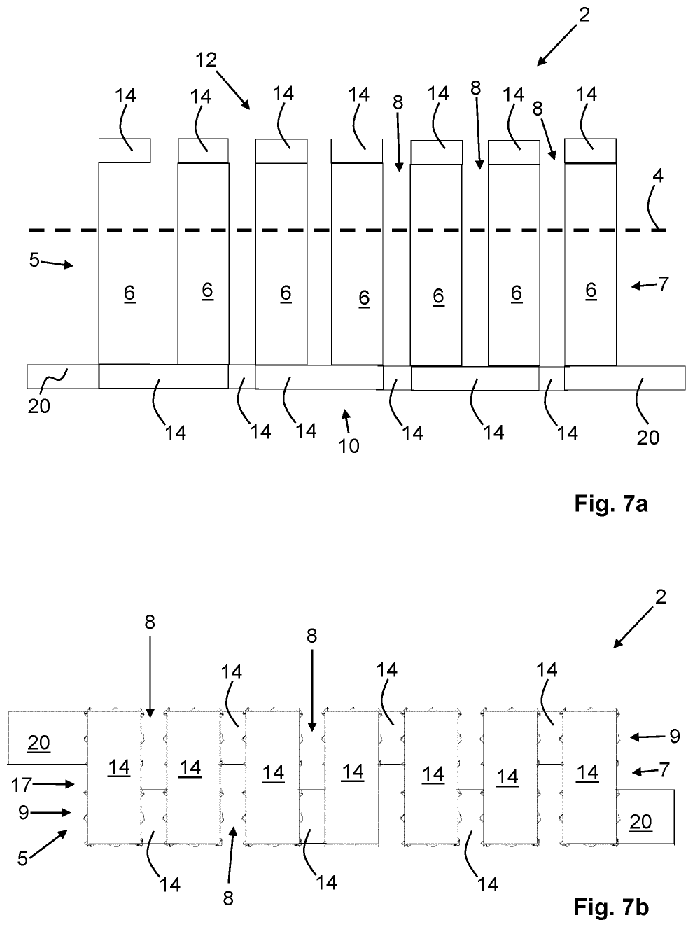

FIGS. 7a and 7b illustrate a heating element 2 according to embodiments. In FIG. 7a, the heating element 2, is shown in a side view. FIG. 7b shows the heating element 2 in a top view.

The heating element 2 of these embodiments resembles in much the heating elements 2, 2′, 2″, 2′″ discussed herein, such as above with reference to FIGS. 1a-4b and 6a-6d. Accordingly, in the following, mainly the differences will be discussed.

The main difference is that in the embodiments of FIGS. 7a and 7b the heating element 2 comprises two rows 9 of heating panels 6.

Again, the heating element 2 has an extension along a first axis 4, indicated with a broken line. Seen along the first axis 4, the heating element 2 has a first end portion 5 and an opposite second end portion 7.

Again, the heating element 2 comprises a number of fluid permeable heating panels 6. The heating panels 6, in this example 7 heating panels 6 per row 9 of heating panels, are arranged adjacent to each other along the first axis 4 with an interspace 8 between adjacent heating panels 6 in each row 9 of heating panels 6. Each row 9 may comprise less or more than 7 heating panels 6.

Moreover, there are also interspaces 17 between adjacent heating panels 6 of adjacent rows 9 of heating panels 6.

Again, the heating element 2 has a 3-dimensional shape which is delimited in part by a first lateral side 10 and an opposite second lateral side 12.

Again, within the heating element 2, the heating panels 6 are electrically connected in series via electrical connectors 14. The electrical connectors 14 are arranged at the first and second lateral sides 10, 12.

According to these embodiments and others including at least two rows 9 of heating panels 6, the heating panels 6 of the at least two rows 9 of heating panels 6 are electrically connected in series along an electrically conductive path, from the first end portion 5 to the second end portion 7 of the heating element 2, seen along the first axis 4, via the electrical connectors 14 being arranged alternatingly at the first and second lateral sides 10, 12.

Some of the electrical connectors 14 extend between adjacent heating panels 6 within a row 9 of heating panels 6 and some of the electrical connectors 14 extend between heating panels 6 of adjacent rows 9 of heating panels 9. Thus, the electrically conductive path is meandering through the heating element 2 from the first end portion 5 to the second end portion 7.

If the heating element 2 comprises only two rows 9 of heating panels 6, as in these embodiments, the heating panels 6 of the two rows are electrically connected in series alternatingly connecting adjacent heating panels 6 within a first row and within a second row, and alternatingly connecting adjacent heating panels 6 of the first and second rows 9, such that all heating panels 6 of the first and second rows 9 are electrically connected in series via an electrically conductive path meandering from the first end portion 5 of the heating element 2, to its opposite second end portion 7. Since the heating element 2 comprises only two rows 9 of heating panels 6, adjacent heating panels 6 of the two adjacent rows 9 are connected to each other via the electrical connectors 14 at one of the lateral sides, in these embodiments at the second lateral side 12. Adjacent heating panels 6 within each row 9 are connected to each other via the electrical connectors 14 at the other lateral sides, in these embodiments at the first lateral side 10.

The heating element 2 comprises two terminals 20 for connecting electric power to the heating element 2.

Again, electrically non-conductive spacer elements (not shown) may be arranged between adjacent heating panels 6 of the respective rows 9 of heating panels 6. The spacer elements are arranged between the heating panels 6 in a manner such that they do not impede the flow of fluid to be heated through the heating element 2, 2′, at least not to any substantial extent.

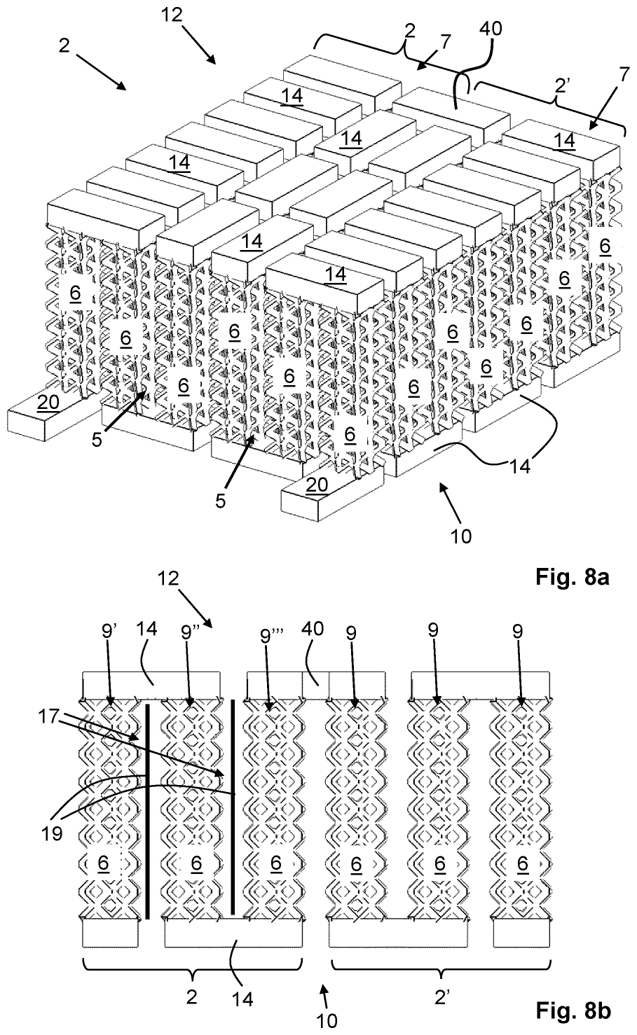

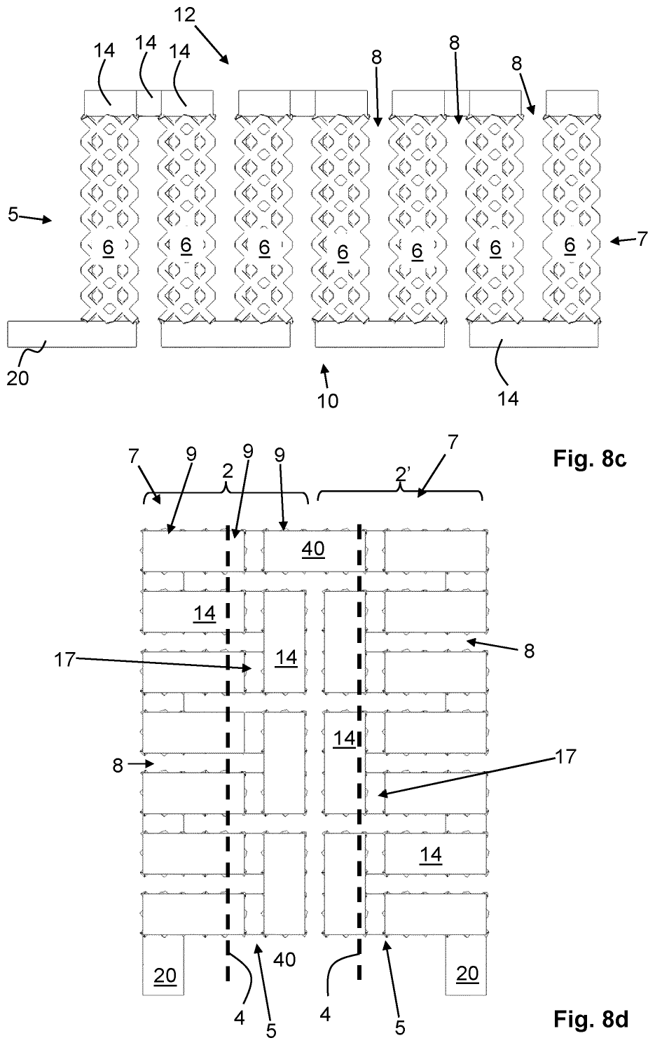

Moreover, one or more electrically non-conductive further spacer elements (not shown) may be arranged between adjacent heating panels 6 of the adjacent rows 9 of heating panels 6. (See FIG. 8b where similar such further spacer elements 19 are schematically indicated.)

According to some embodiments, such further spacer elements may at least partially delimit the flow path through the heating element 2 into separate flow passages extending in parallel with the first axis 4.

Again, the heating element 2 may be arranged in a housing to collectively form a fluid heater.

According to alternative embodiments, a fluid heater may comprise two or more heating elements 2 discussed with reference to FIGS. 7a and 7b arranged in a housing of the fluid heater. The two or more heating elements may be connected in series or in parallel. In such embodiments, the terminals 20 may be arranged at opposite ends of the fluid heater or at one end of the fluid heater.

FIGS. 8a-8d illustrate two heating elements 2, 2′ according to embodiments. In FIG. 8a, the heating elements 2, 2′ are shown in an isometric view. In FIG. 8b, the heating elements 2, 2′ are shown in an end view. FIG. 8c shows the heating elements 2, 2′ in a side view. FIG. 8d shows the heating elements 2, 2′ in a top view.

The heating elements 2, 2′ of these embodiments resemble in much the heating elements 2, 2′ discussed herein, such as above with reference to FIGS. 1a-6d and particularly the embodiments discussed above with reference to FIGS. 7a and 7b. Accordingly, in the following, mainly the differences will be discussed.

The main difference is that in the embodiments of FIGS. 8a-8d each heating element 2, 2′ comprises three rows 9 of heating panels 6.

Again, each heating element 2, 2′ has an extension along a first axis 4, indicated with a broken line. Seen along the first axis 4, each the heating element 2 has a first end portion 5 and an opposite second end portion 7.

Again, the two heating elements 2, 2′ are arranged with their respective first axis 4 in parallel.

In these embodiments, each row 9 comprise 7 heating panels 6 arranged adjacent to each other along the first axis 4 with an interspace 8 between adjacent heating panels 6 in each row 9 of heating panels 6 and interspaces 17 between adjacent heating panels 6 of adjacent rows 9 of heating panels 6. Each row 9 may comprise less or more than 7 heating panels 6.

Again, within each heating element 2, 2′, the heating panels 6 are electrically connected in series via electrical connectors 14. The electrical connectors 14 are arranged at the first and second lateral sides 10, 12.

According to these embodiments and others including at least two rows 9 of heating panels 6, the heating panels 6 of the at least two rows 9 of heating panels 6 are electrically connected in series along an electrically conductive path, from the first end portion 5 to the second end portion 7 of the heating element 2, 2′, seen along the first axis 4, via the electrical connectors 14 being arranged alternatingly at the first and second lateral sides 10, 12.

Some of the electrical connectors 14 extend between adjacent heating panels 6 within a row 9 of heating panels 6 and some of the electrical connectors 14 extend between heating panels 6 of adjacent rows 9 of heating panels 9. Thus, the electrically conductive path is meandering through the heating element 2 from the first end portion 5 to the second end portion 7.

In more detail, if the heating element 2, 2′ comprises three or more rows 9 of heating panels 6 i.e., a first outermost row 9′, a second outermost row 9″, and at least one intermediate row 9″ between the first and second outermost rows 9′, 9′″, the heating panels 6 of the three or more rows 9 are electrically connected in series via an electrically conductive path through the heating element 2, 2′, see FIG. 8b. Connecting heating panels of adjacent rows, the electrically conductive path can be arranged to meander through the heating element across the first axis.

For instance, a heating panel 6 of the first outermost row 9′ is electrically connected by an electrical connector 14 with an adjacent heating panel 6 of an adjacent intermediate row 9″ of heating panels 6. If the heating element comprises more than one intermediate row of heating panels adjacent heating panels of adjacent intermediate rows are connected by electrical connectors until the second outermost row 9″ is reached and a heating panel 6 of the relevant intermediate row 9″ is connected by an electrical connector 14 with an adjacent heating panel 6 of the second outermost row 9′″. Thus, there are formed serially connected lines of heating panels 6 extending across the at least three rows 9′, 9″, 9″ of heating panels 6 and across the first axis 4. These serially connected lines of heating panels 6 are in turn connected alternatingly by electrical connectors 14 via adjacent heating panels 6 within the first outermost row 9′ and adjacent heating panels 6 within the second outermost row 9″, such that all heating panels 6 of the at least three rows 9′, 9″, 9″ are electrically connected in series via an electrically conductive path meandering from the first end portion 5 of the heating element 2, 2′ to the second end portion 7.

Again, the two heating elements 2, 2′ are electrically connected in series. An electrically conductive element 40 is arranged between a respective heating panel 6 of the heating elements 2, 2′ at the second end portion 7. Via the electrically conductive element 40 the two heating elements 2, 2′ are electrically connected.

Each of the of the heating elements 2, 2′ comprises a terminal 20 for connecting electric power to the heating elements 2, 2′. Since the two heating elements 2, 2′ are electrically connected in series, the terminals 20 are both arranged at the same end portion of the two heating elements 2, 2′, in the illustrated embodiments at the first end portion 5.

Again, electrically non-conductive spacer elements (not shown) may be arranged between adjacent heating panels 6 of the respective rows 9 of heating panels 6. The spacer elements are arranged between the heating panels 6 in a manner such that they do not impede the flow of fluid to be heated through the heating element 2, 2′, at least not to any substantial extent.

Also, one or more electrically non-conductive further spacer elements 19 may be arranged between adjacent heating panels 6 of adjacent rows 9 of heating panels 6. Two such further spacer elements 19 are schematically indicated in FIG. 8b.

According to some embodiments, such further spacer elements 19 may at least partially delimit the flow path through the heating element 2, 2′ into separate flow passages extending in parallel with the first axis 4.

Again, the two heating elements 2, 2′ may be arranged in a housing to collectively form a fluid heater.

According to alternative embodiments, a fluid heater may comprise only one of the heating elements 2, 2′ discussed with reference to FIGS. 8a-8d arranged in a housing of the fluid heater. In such embodiments, the terminals 20 may be arranged at opposite ends of the fluid heater.

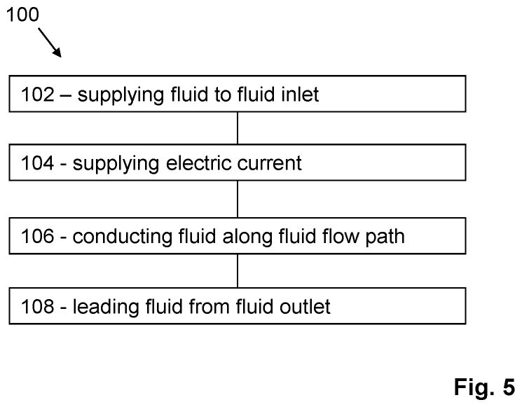

FIG. 5 illustrates a method 100 for heating a fluid in an electric fluid heater 30 according to any one of aspects and/or embodiments discussed herein. Accordingly, in the following, reference is also made to FIGS. 1a-4b and 6a-8d.

The method 100 comprises steps of:
supplying 102 a fluid to the fluid inlet 34,
supplying 104 an electric current to the at least one heating element 2, 2′ in order to heat the heating panels 6,
conducting 106 the fluid along the fluid flow path through the heating panels 6 to the fluid outlet 36, and
leading 108 the fluid from the fluid outlet 36.

Accordingly, the fluid to be heat is supplied to the fluid inlet 34 of the electric fluid heater 30 in the step of supplying 102. The fluid may be supplied to the fluid inlet 34 via a conduit devised for conducting fluid to the electric fluid heater 30 and the fluid inlet 34.

The step of supplying 104 electric current to the heating element 2, 2′ suitably is performed continuously over a period of time, during which the fluid to be heated passes the electric fluid heater 30. The step of supplying 104 electric current to the heating element 2, 2′ may be started prior to or simultaneously with the step of supplying 102 fluid to the fluid inlet 34.

During the step of conducting 106 the fluid along the fluid flow path, the fluid is heated by the heating panels 6. The members 45 of the 3-dimensional structure of the heating panels 6 are heated by the electric current and the heat is transferred to the fluid as it passes through the heating panels 6.

In the step of leading 108 the fluid from the fluid outlet 36, the heated fluid is led to downstream use thereof, such in a downstream process utilising the heated fluid. The fluid may be led from the fluid outlet 36 via a conduit devised for conducting the heated fluid from the electric fluid heater 30 and the fluid outlet 36.

According to embodiments, the fluid may be selected from for example but not limiting air, hydrogen, carbon dioxide, synthesis gas, pyrolysis gases, hydrocarbon, steam, and methane or a combination thereof.

According to embodiments, the heating element as defined hereinabove or hereinafter or the heating panels as defined hereabove or hereinafter may be coated with one or more catalytic material.

In this manner, the method 100 may be utilised in a process such as e.g., preheating of process gas, and heating for catalytic reactions.

It is to be understood that the foregoing is illustrative of various example embodiments and that the invention is defined only by the appended claims. A person skilled in the art will realize that the example embodiments may be modified, and that different features of the example embodiments may be combined to create embodiments other than those described herein, without departing from the scope of the invention, as defined by the appended claims.

1. A heating element for an electric fluid heater, the heating element having an extension along a first axis and comprising fluid permeable heating panels extending at an angle within a range of 45-90 degrees to the first axis and being arranged adjacent to each other along the first axis with an interspace between adjacent heating panels,
wherein each heating panel comprises a 3-dimensional structure, the 3-dimensional structure comprising a multitude of members of at least one electrically conductive material,
wherein the heating element has a 3-dimensional shape which is delimited in part by a first lateral side and an opposite second lateral side, the first and second lateral sides extending substantially in parallel with the first axis and the heating panels extending between the first and second lateral sides,
wherein the heating panels are electrically connected in series via electrical connectors arranged at the first and second lateral sides, and
wherein the 3-dimensional structure comprises at least three members arranged after each other along the first axis and connected to each other at nodes.

2. The heating element according to claim 1, wherein an electrically conductive path is provided through the heating element by the heating panels and the electrical connectors, wherein the heating element has a length along the first axis, and wherein the electrically conductive path is longer than the length along the first axis.

3. The heating element according to claim 1, wherein the heating panels are electrically connected in series only via the electrical connectors arranged at the first and second lateral sides.

4. The heating element according to claim 1, wherein each of the heating panels is a result of an additive manufacturing process.

5. The heating element according to claim 1, wherein the electrical connectors are a result of an additive manufacturing process.

6. The heating element according to claim 1, comprising at least 2 heating panels.

7. The heating element according to claim 1, comprising at least two rows of heating panels arranged adjacent to each other along the first axis.

8. The heating element according to claim 7, wherein each of the at least two rows of heating panels comprises at least 2 heating panels.

9. The heating element according to claim 7, wherein the heating panels of the at least two rows of heating panels are electrically connected in series along an electrically conductive path, from a first end portion of the heating element to an opposite second end portion of the heating element seen along the first axis, via the electrical connectors being arranged alternatingly at the first and second lateral sides, and
wherein some of the electrical connectors extend between adjacent heating panels within a row of heating panels and some of the electrical connectors extend between heating panels of adjacent rows of heating panels.

10. The heating element according to claim 1, wherein a thickness of the members is within a range of 0.05-10 mm, or within a range of 0.1-4 mm, or within a range of 0.2-1 mm, and
wherein a length of the members is within a range of 0.1-50 mm, or within a range of 0.2-15 mm or within a range of 0.5-5 mm.

11. The heating element according to claim 1, wherein the members are connected at nodes to form a multitude of unit cells.

12. The heating element according to claim 1, comprising electrically non-conductive spacer elements arranged between adjacent heating panels of a row of heating panels at the first and second lateral sides.

13. The heating element according to claim 12, wherein along the first lateral side, one of the electrical connectors extends between two adjacent heating panels to form a pair of heating panels and one of the spacer elements is arranged between the pair of heating panels and a further adjacent heating panel, and
wherein along the second lateral side, one of the spacer elements is arranged between the two heating panels of the pair of heating panels and one of the electrical connectors extends between one of the heating panels of the pair of heating panels and the further adjacent heating panel.

14. The heating element according to claim 1, wherein the heating element comprises at least two rows of heating panels and at least one electrically non-conductive further spacer element arranged between adjacent heating panels of adjacent rows of heating panels.

15. The heating element according to claim 1, wherein the heating panels are configured to be electrically heated up to a temperature of 1450 degrees Celsius, up to a temperature of 1900 degrees Celsius, or up to a temperature within a range of 1700-1900 degrees Celsius, or up to a temperature within a range of 1600-2000 degrees Celsius.

16. The heating element according to claim 1, wherein a first heating panel differs from a second heating panel by any one or a combination of:
the 3-dimensional structure;
a cross-sectional area, thickness or width of the members;
a size, shape, or number of voids within the heating panels; and
a length along the first axis of the heating panels.

17. The heating element according to claim 1, wherein the 3-dimensional structure is a self-supporting structure.

18. An electric fluid heater, comprising:
at least one heating element according to claim 1; and
a housing having a fluid inlet and a fluid outlet,
wherein a fluid flow path for the fluid to be heated is defined within the housing, and
wherein the at least one heating element is arranged with its first axis extending along at least part of the fluid flow path.

19. The electric fluid heater according to claim 18, comprising an insulation material arranged at least along part of the fluid flow path.

20. A method for heating a fluid in an electric fluid heater according to claim 18 comprising steps of:
supplying a fluid to the fluid inlet;
supplying an electric current to the at least one heating element in order to heat the heating panels;
conducting the fluid along the fluid flow path through the heating panels to the fluid outlet; and
leading the fluid from the fluid outlet.
